(19) United States
(12) Patent Application Publication
(10) Pub. No.: US 2002/0038371 A1
(43) Pub. Date: Mar. 28, 2002

(54) Communication method and system

(76) Inventor: Simon Alan Spacey, London (GB)

Correspondence Address: SIMON ALAN SPACEY, SUITE 94, 2 LANSDOWNE ROW, LONDON, WIJ GHL, GB

(21) Appl. No.: 09/908,939

(22) Filed: Jul. 20, 2001

(30) Foreign Application Priority Data
Aug. 14, 2000 (GB) 0019959.6

(51) Int. Cl. G06F 15/16

(52) U.S. Cl. 709/227

(57) ABSTRACT

This invention provides a method allowing communications to pass between private network segments without the need for holes in the firewalls of those networks. The method uses an Intermediary machine located somewhere on a public network as described herein. A component in the private service network opens one or more outbound connections to the Intermediary and leaves these connections open waiting for a response. These outbound connections pass transparently through any restrictive firewalls on the private service network as they these firewalls are typically set-up to block only unprompted inbound requests. A component on the client private network then connects to the same Intermediary with an outbound connection and sends it a request that should be serviced by a server located on the otherwise inaccessible private service network. The Intermediary passes this client request on to the private service network as a response to the waiting outbound connection previously opened by the service network component to the Intermediary. The client request thus enters the private service network a response to a previously opened outbound connection from the service component and so is not blocked by the private service networks firewall. The service component reformats the request and transmits it on to the service machine in the private network as required. The invention as presented has advantages over previous inter-network communication methods including, most notably, that no changes are required to either: the service or client software or to private network and firewall settings, and that security and compression can be transparently added to network communications The invention as presented also provides a new method for transparent service clustering and load balancing.

### TECHNICAL FIELD

The present invention relates generally to a method of and system for providing services over a communication channel or network through an intermediary apparatus. In particular the invention relates to networking, inter-network communication and routing, inter-network security, communication protocols at various network layers and client-server applications.

More particularly the invention relates to a method and system which, amongst other things, can be used by a client to connect to a service-providing network that the client may otherwise be unable to connect to because of a restrictive firewall or other device.

### BACKGROUND OF THE INVENTION

Providing a service over a communication medium such as the Internet demands that the party requesting the service (the client) is able to address its requests for service to a service-providing machine. Up to now, this has meant that the service-providing machine must have a fixed or “static” address for the client to send requests to. With the growth of private networks (computers protected behind a firewall or a gateway), Digital Synchronous Lines (DSL), dynamic IP allocation and the rapidly decreasing number of free static IP addresses on the Internet, a solution is needed that allows client applications to communicate with service providing applications without the need for static addresses. The present invention seeks to resolve this and other service-providing problems.

It would be advantageous for a remote client to be able to access services on a restricted server or service providing machine (i.e. where it is behind a restricted firewall, proxy server or the like), for instance a staff member being able to remotely access his workplace server from his home PC through the Internet. The present invention also seeks to fulfill this need.

Disadvantageously, in a known SOCKS Bind process, changes are required to the service providing application or the client application and a SOCKS Bind synchronisation channel is required (which in-itself requires a static address). The present invention also seeks to provide a solution without these problems.

### SUMMARY OF THE INVENTION

It is a general object of the present invention to provide improved provision of services over a communication channel through an intermediary server. In this context, the invention provides a method for services to be made available to clients using a virtual address that eliminates the need for a fixed or “static” service address.

It is also a general object of the present invention to provide a method and system enabling a service providing machine to receive client requests even where the service machine is a restricted server (behind, for example, a firewall) or service machine or has a dynamic (changing) address. Consequently a remote client beyond a firewall of a service-providing machine may connect with the machine.

A further object of the invention is to provide a method and system for establishing a Virtual Private Network

According to an aspect of the invention there is provided a method of connecting a preferably remote client to a server for the provision of services therebetween, the method comprising the server establishing a client-type connection with an intermediary and the client establishing a client-type connection with the intermediary.

Preferably a proxy client or proxy client component establishes the connection with the intermediary on behalf of the server. The server may be a restricted server. The proxy client, as introduced and conceived herein, is not necessarily a physical entity and therefore as a component may be a virtual client. The proxy client or component is preferably associated with the server and has a client relationship with both the server and the intermediary site.

The proxy client or component acts as a proxy (surrogate) for the ultimate client on the service-providing network and initiates an outward bound connections with the intermediary or intermediary machine for the purposes of receiving client requests therefrom. By initiating the connection to the intermediary machine from inside the service network, the proxy client component is able to communicate through any restrictive firewalls (allowing outward bound connections only), proxy servers and other items on a private network because it has the characteristics of a client requesting services and not a service waiting for inbound requests.

The ultimate client application sends a request for service to a “virtual address” on the intermediary, the intermediary apparatus then analyses the virtual address to identify the correct waiting proxy client for forwarding. The intermediary then passes this request on as a response through the open proxy client connection. The proxy client is allowed to receive the response through any firewall or proxy server in the same way a client application would receive a response through such items. Generally, the proxy client then forwards the request on through the service-providing network and, as in a first embodiment below, receives responses and forwards them back to the intermediary for delivery to the ultimate client. Virtual addresses may be removed or transformed through the process as required.

According to another aspect of the invention there is provided a method of establishing a communication channel between a client and a server via an intermediary site for the provision of services between server and client, the method using a virtual address system. This eliminates the need for a fixed or “static” service address by using the address space associated with the intermediary more fully. The virtual address system can be used to consolidate disparate services into a coherent address scheme (for example consolidating departmental web servers into a coherent company address scheme).

In another aspect, the invention provides a method of network or inter-network (such as the Internet or Internet-type) communication, the method comprising a first client or server establishing a client-type relationship with an intermediary server, a second client or server establishing a client-type relationship with the intermediary server and the intermediary server facilitating communications between the first client or server and the second client or server.

The intermediary apparatus differs from a proxy server or a router in two important ways. Firstly, in use it has at least one but preferably a pool of proxy client connections already open and waiting for requests instead of initiating new service request connections on an as needed basis. Secondly, although it is necessary for the proxy client to be able to open a connection to the intermediary apparatus, it may be impossible for the intermediary apparatus to open a connection to the proxy client because of restrictive firewalls, proxy servers or dynamic address issues.

By communicating network level requests in accordance with a second embodiment of the invention, a Virtual Private Network (VPN) can easily be constructed between two networks and/or machines through the intermediary. Here, the method of the invention differs from any existing VPN (including AltaVista tunnel, Cisco PIX, PPP, PPTP, Unix Secure Shell, IPSec, L2F, L2TP) in that communication is via an intermediary and in that a proxy client and optional modified router component are preferably required on each network or machine. The VPN provided has the advantage that it removes the need for a static network address and can be used without re-configuring a firewall or proxy server.

According to a further aspect of the invention there is provided a method of establishing a Virtual Private Network (VPN) between at least two machines, the method comprising a first machine or a component on behalf of the first machine establishing a client-type connection with an intermediary server and a second machine or a component on behalf of the second machine establishing a client-type connection with the intermediary server. Each machine may be part of the same or a different private network separated by the intermediary through which they communicate preferably at the network layer allowing for network-to-network machine-to-machine or machine-to-network VPNs.

Other aspects of the invention are defined in the appended claims. According to certain other aspects of the invention there are provided means for performing the methods of the invention.

All aspects of the invention are compatible with standard encryption and compression techniques and are flexible enough to be used with any network topology (including static and dynamic addresses), communication medium, communication protocol and any application service.

### BRIEF DESCRIPTION OF THE DRAWINGS

Implementations and embodiments of the present invention will now be described, by way of example only, with reference to the accompanying drawings. In the drawings:

FIG. 1 shows the components constructed in accordance with the invention and their client-server relationship.

FIG. 2 details the stages nominally involved in the Application Layer communication process carried out in accordance with the invention through the intermediary and proxy client.

FIG. 3 details the stages nominally involved in the Network or Transport Layer communication process through the intermediary carried out in accordance with the invention.

FIG. 4 shows the network layers that the two preferred embodiments of the invention, described hereinafter, operate at. It can be seen that the first embodiment operates at the application layer and the second operates at the network layer.

FIG. 5 shows the network topology used to illustrate the first embodiment. This network topology has been selected to demonstrate the application layer virtual addressing features of the invention in a realistic situation where a dial-up client connects to a company web server that is on a private network behind a firewall.

FIG. 6 shows a flow chart of the illustration application layer connection using the first embodiment.

FIG. 7 shows the network topology used to illustrate the second embodiment. This network has been selected to demonstrate the machine-to-machine, machine-to-network and network-to-network communication features of the invention in a realistic situation where a machine on a satellite office contacts an e-mail server on the main office network through the Internet. This topology includes two restrictive (out only) firewalls, two private networks, an intermediary on the Internet and modified routers.

FIG. 8 shows a flow chart of the illustration network layer connection using the second embodiment.

### DETAILED DESCRIPTION

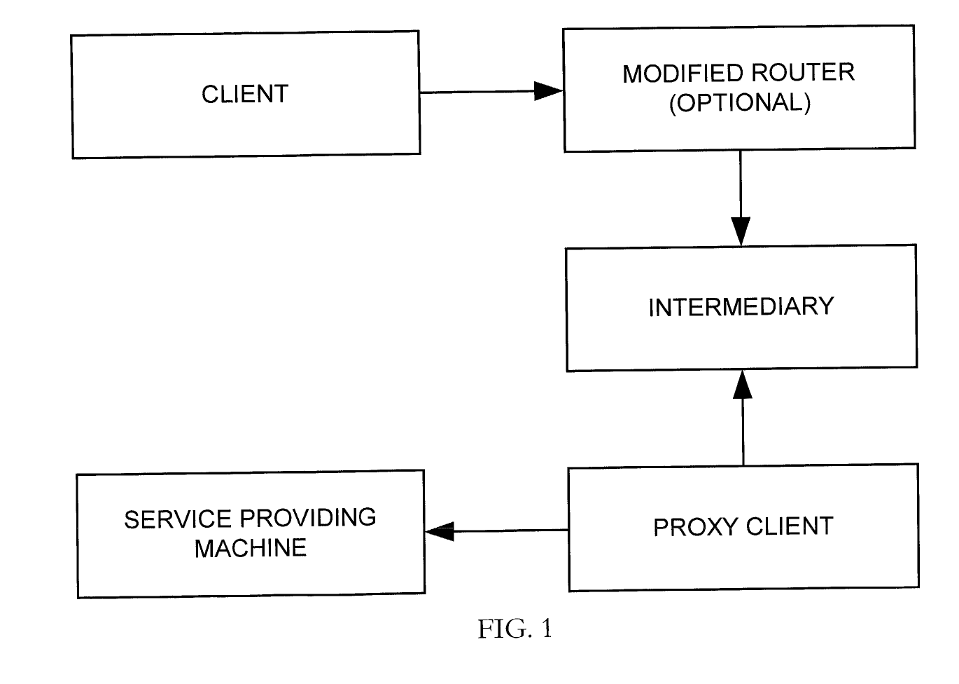

Three component roles are provided and these are illustrated in FIG. 1. The first is a modified router that is used optionally to forward network or transport layer level information through the intermediary apparatus. The second is the intermediary apparatus itself, which receives client requests and service responses. The intermediary uses a virtual addressing scheme to forward the client requests to the correct open proxy client connection. The third component is the proxy client itself This component opens a connection to the intermediary machine, receives any requests from it and forwards these requests on to a service provider. FIG. 1 shows these components and the Client-Server relationship of the components (the direction of the arrows is from client component to server).

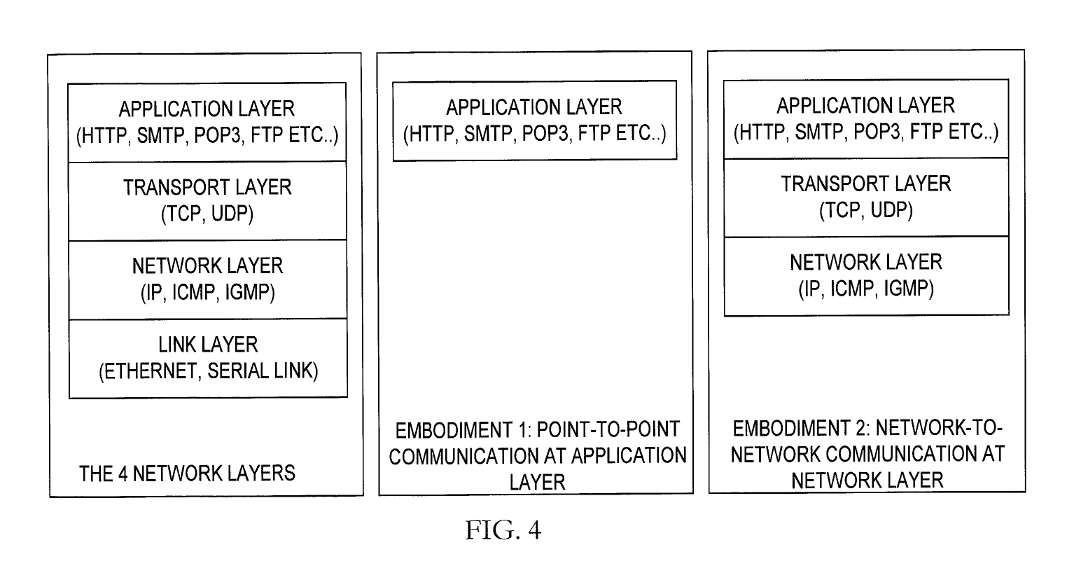

The client contacts the service provider through the intermediary using a virtual addressing scheme. There are two broad types of virtual addressing scheme that can be used. These are characterised as being either at the Application layer or at the Network or Transport layer of the communication protocol stack (FIG. 4). Both virtual addressing schemes are described below. Many alternative schemes are envisaged.

Both virtual addressing schemes allow for client and service network authentication and encryption. Client authentication can be performed by any of the components or a service machine itself. Service authentication can be performed through the proxy client at the intermediary apparatus and may be required to prevent service “spoofing” where a hacker's service would lock a virtual address wrongly to receive client requests without authority. Ay authentication method can be employed on the component selected for authentication. Methods include any combination of: PAP, CHAP, Challenge Response, X.509 Certificates, Host address, Private or Public Keys or other. The exact authentication method and where it is performed is implementation dependent.

By encrypting connections, a secure communications channel can be provided. The connections implemented in the invention are compatible with all encryption methods including IPSec and Block and Stream Ciphers (RSA, Blowfish, RC2, RC4 etc.). Additionally the components can be used to provide a compressed communication channel using standard compression techniques to provided faster communication between client-server components.

### APPLICATION LAYER VIRTUAL ADDRESSING

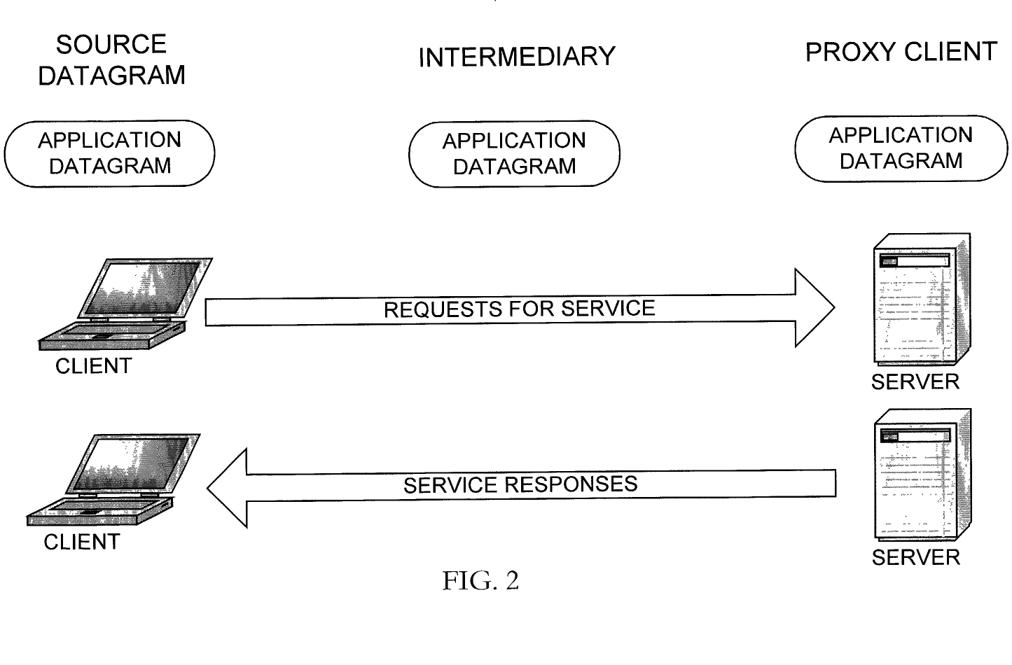

FIG. 2 shows the components nominally involved when using the invention with application layer virtual addressing. A characteristic of this addressing mode is that the proxy client “masquerades” as the real client on the service network so as to receive the service responses from the service application. This is as opposed to the service application sending responses directly to the client bypassing the proxy client on the return route.

The communication process associated with this addressing scheme as illustrated in FIG. 2 is summarised thus:

1. The proxy client opens an outbound transport or network layer (e.g. TCP/IP) client connection to the Intermediary apparatus and registers a virtual addresses with it

2. The proxy client holds the connection open and waits for a client request to be returned from the intermediary

3. A client sends an application layer request to a vial address on the intermediary

4. The intermediary interprets the address, identifies the correct destination proxy client and sends the request through the appropriate open waiting proxy client connection

5. The proxy client opens an outbound transport or network layer (e.g. TCP/IP) connection to the requested service providing application and sends it the application layer request

6. The service application interprets the request and returns any response to the waiting proxy client

7. The proxy client forwards the service response through its still open transport or network layer connection to the intermediary

8. The intermediary returns the response to the real client through the open client connection

9. The client closes its connection with the intermediary and this ends the transaction

The process of this virtual addressing scheme is described further with an example in the first of the preferred embodiments. The scheme is particularly suited for providing a defined service application through the intermediary such as a web server (using a virtual HTTP application address) or an e-mail server (using a virtual SMTP application address).

The scheme requires the interpretation of the virtual client address and possible transformation of application requests between the virtual address scheme of the intermediary and the real address scheme of the application service provider. Any such transformation can be performed at either the intermediary component or the proxy client component (steps 4 or 5). Likewise, the scheme may require transformation of service responses so that the ultimate client is not confused. This transformation can also be performed at either component (step 7 or 8) above.

Many modifications are possible on the above stages. Some of the most obvious include: the proxy client connecting to the intermediary to pick-up client requests intermittently instead of holding a connection open (step 2) and the configuration of the intermediary to forward client requests to a particular proxy client based on other factors than a virtual address (step 4). The choice of proxy client could for example be based on the time of day, the spare capacity of a service, the client IP address, the application protocol and other factors to gain benefits from distributed load services or the removal of the need for a specially constructed application address. Finally, the registration of the proxy client virtual address (step 1) may be implicit from the proxy client's IP or other information removing the need for a strict registration process.

### NETWORK OR TRANSPORT LAYER VIRTUAL ADDRESSING

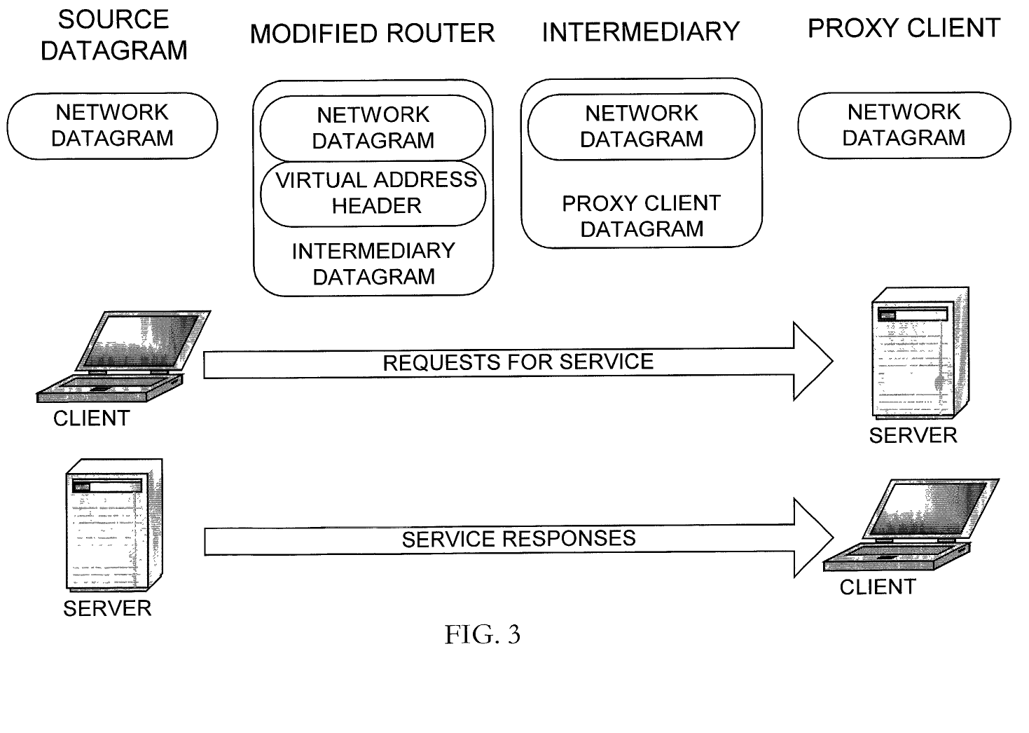

FIG. 3 shows the components nominally involved when using the invention with Network or Transport layer virtual addressing. A characteristic of this virtual addressing scheme is the optional encapsulation of datagram client requests in a network packet routable to the intermediary. A second characteristic is that the proxy client transmits the original client datagram at the network layer on the service network and may not masquerade as the client. This second characteristic means that the service application may send responses to the address of the ultimate client system and not back through an open transport layer connection with the proxy client.

The communication process associated with the addressing scheme as illustrated in FIG. 3 is summarised thus:

1. The proxy client opens an outbound transport or network layer (e.g. TCP/IP) client connection to the intermediary apparatus and registers a virtual addresses with it

2. The proxy client holds the connection open and waits for a client request datagram from the intermediary

3. A client sends a network layer request to the address of the destination service application probably located on a different network or subnet

4. The client network request datagram is encapsulated and sent to the intermediary

5. The intermediary interprets the encapsulated datagram request, identifies the correct destination proxy client and sends the request through the appropriate open waiting proxy transport or network layer connection

6. The proxy client repeats the client request datagram on the service network

7. The service application receives the datagram through a link-layer connection to the service network, interprets the request and returns any response to the network layer address of the original client

8. The response may be encapsulated and sent back through the intermediary by a modified router on the service network, if so

9. The intermediary interprets the encapsulated datagram response, identifies the correct destination proxy client on the client network and sends the request through the appropriate open waiting proxy transport or network layer connection to the client network

10. The client side proxy client repeats the service response network packet on the client network so that it can be received by the original client

The process of this virtual addressing scheme is described further with an example in the second of the preferred embodiments. The scheme is particularly suited for providing undefined services through the intermediary in the way of network-to-network communication. This inter-network communication can be secured to provide a Secure Virtual Private Network over the Internet. The addressing scheme is compatible with all network layer communication protocols and because transport layer and application layer protocols are encapsulated in network layer communications (see FIG. 4), the scheme is generally protocol flexible. Compatible protocols include: IPX/SPX, NetBIOS, NetBEUI, AppleTalk, WINS, PPP, IP, ICMP (Ping etc. IGMP, TCP/IP, UDP, HTTP, SMTP, POP and numerous others.

Client requests can be sent through the intermediary in a variety of methods in accordance with the invention. A first is to use a modified router application accessible to the client or client network. This modified router encapsulates the client request datagram in a datagram that is routable to the intermediary. The method of encapsulation could be in accordance with the Generic Routing Encapsulation methods outlined in RFCs 1/01 and 1/02 and is not restricted by the invention. Using this first case, a route may need to be configured on the client that directs requests for the service network to the modified router for forwarding.

The datagram can be encapsulated with either an extra virtual address header that the intermediary uses to identify the corresponding proxy client or without a virtual address header. In this second case, the intermediary can determine the correct corresponding proxy client from datagram analysis. Examples of possible datagram analysis methods in accordance with the invention include using the IP “to” address of a request IP datagram to indicate the correct proxy client and to examine the contents of the datagram for application layer protocol indicators (such as HTTP headers).

A second method for sending client request datagrams through the intermediary is to change the client so that it directs requests through the intermediary without the need for a modified router. This can be achieved by either including the functionality of the modified router in the client or, in some cases, by changing the client configuration. An example of where a client application can be configured to use the intermediary is with a web browser. The web browser can be set to use the intermediary as a proxy server and so send network level browser requests to it. The intermediary could then use datagram analysis of the HTTP request header to identify the correct proxy client to forward the request through.

Additionally, clients can be made to send requests directly to an intermediary that is configured to act as a proxy server for a service network without additional software or being re-configured (altering step 4). As an example, a company could purchase an Internet name (say www.orang.com) and provide a public DNS entry that connects the name directly to the intermediary apparatus. The company's private web server can then be published using a proxy client to the intermediary machine. Client requests for www.orang.com would thus be sent directly to the intermediary, which would analyse the datagrams and forward them to the proxy client.

It is a distinguishing characteristic of this virtual addressing scheme that the proxy client acts as network repeater and not a transport layer client on the service network. The proxy client repeats client network level requests at the link-layer of the service network. In not acting as a client to the service-providing machine, the responses are sent through the service network link-layer directed to the original request “from” address in the repeated datagram of the ultimate client. The normal consequence of this is that the response will be routed out of the service network and to the client bypassing both the proxy client and the intermediary apparatus on their return.

Several modifications are available to allow responses to travel back through the intermediary and so benefit from being able to pass into a private client network (through the open request linked with the intermediary or a proxy client) and to benefit from any encryption or compression employed. The first modification is for either the intermediary or the proxy client to masquerade as the real client by replacing the “from” address in the datagram with its own address. This first approach then brings this addressing method closer to that employed in Application layer virtual addressing but with the added benefits of working with any application protocol and a VPN connection.

The second modification is to include a modified router on the service network that encapsulates service responses destined for the original client network and passes them to the intermediary. The intermediary can then either pass these communications back to the client network through a proxy client on the client network or through the open client connection path that was used to send the original client request to the intermediary. Thus the general approach shown previously in FIG. 3 includes two modified routers and two proxy clients—one for the each of the client and service networks). It is recognised however that a proxy client masquerading at the network level may be the preferred implementation modification.

Again, as with Application layer virtual addressing, the proxy client may connect to the intermediary on an intermittent basis (step 2). Also, viral addresses may be inferred from other information such as the IP address (steps 1 and 5) as well as other obvious modifications.

Two physical embodiments will now be described illustrating the Application and Network layer virtual addressing schemes described above. It should be understood however that the invention is flexible enough to allow hybrid implementations providing any type of network communication at any of the different communication protocol layers and using different combinations of the three components disclosed. FIG. 4 shows the traditional communication protocol stack and the position of the layers used in the two embodiments.

### PREFERRED EMBODIMENT 1: APPLICATION LAYER VIRTUAL ADDRESSING

The physical embodiment, constructed in accordance with the invention, of application layer virtual addressing is flexible enough to work with any network application service, but, for illustration purposes only, an embodiment will be described with a company publishing its internal Intranet web-site to a client on the Internet. To do this, a dial-up client on the Internet will connect to the private company web-site through a virtual Hyper Text Transport Protocol (HTTP Application Layer Protocol) address on the intermediary and three rules for application layer virtual addresses will be described.

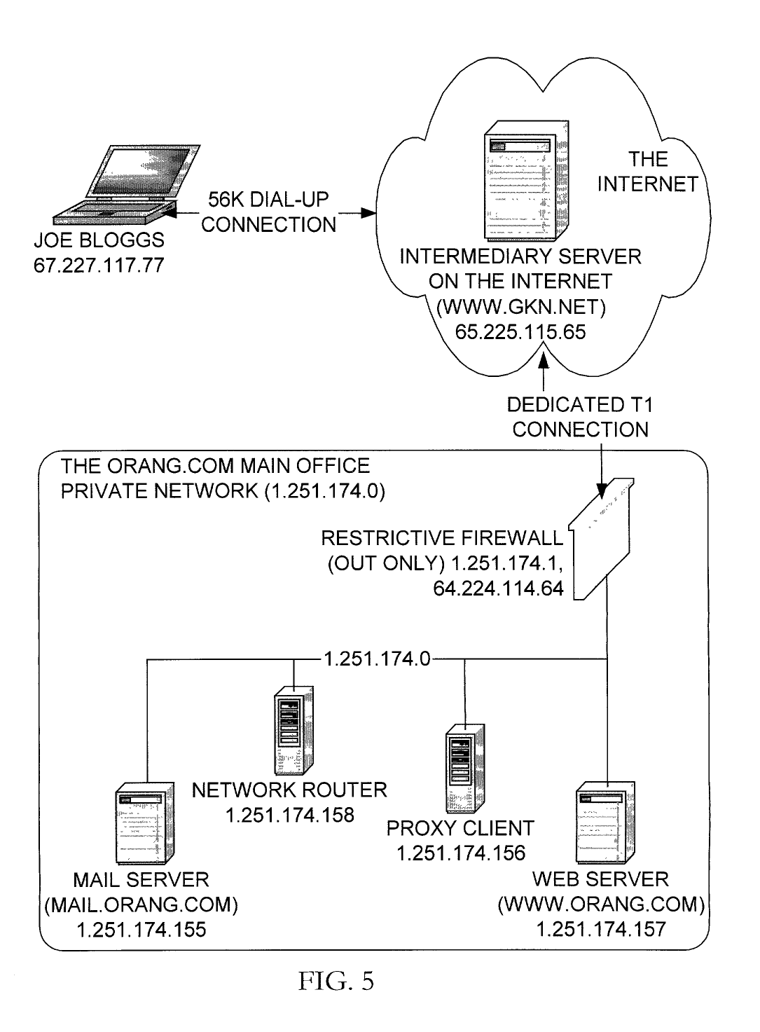

FIG. 5 shows the network topography used to illustrate this embodiment. In this example, the company (orang.com) has a private network that is connected to the Internet for OUTBOUND traffic only. This protection is afforded by a restrictive firewall with masquerading that prevents any communications originating from outside the company network from entering into the company's network. The firewall prevents normal Internet users from seeing the company's internal Intranet web server or from knowing anything about the internal network structure (number of computers, services provided, internal addresses etc.). The method is topology neutral however, and could equally well be used to connect a dial-up client with a web server that is also on a dial-up connection.

A proxy client component is installed so that it can connect to both the internal web server and the intermediary server on the Internet as a client. In the illustration network the proxy client is a dedicated machine on the internal network (1.251.174.156) although its functions could equally well be provided by a software component installed on the actual web server.

The proxy client starts by registering itself with the intermediary machine on the Internet (65.225.115.65) and waiting for client requests. Because the proxy client initiates an OUTBOUND connection to the intermediary, in accordance with the invention, it has the characteristics of a client application on the private network and its communications will pass unhindered through the restrictive firewall with out the need for any configuration changes. Additionally, the orang.com internal web server will be published immediately on the Internet through a virtual address on the intermediary without the need or cost of Internic domain registration for the company, ftp transfers to an ISP or a static address.

The exact registration method used by the proxy client is implementation dependent, but for illustration of this embodiment, a secure Username, Password and host authentication method will be used. The process is summarised thus:

1. The 1.251.174.156 proxy client opens an outbound Secure Socket Layer (SSL) communication layer channel with the intermediary through the firewall using the SSL protocol

2. The proxy client sends a ‘request’ for registration to the intermediary

PW: 12345, UN: Client1

VA: www.orang.com

3. The intermediary verifies that the password and username correspond to the virtual address www.orang.com and that the registration came from a valid host address (in this case that the masquerading firewall 64.224.114.65 is the machine allowed to act as a proxy client for www.orang.com)

4. Given that the registration information is consistent with the virtual address the proxy client is attempting to register, the intermediary holds open the SSL proxy client connection ready to return requests through. Otherwise it simply closes the proxy client connection to refuse the connection

It should be noted that this registration protocol is extremely simple and that the intermediary could be extended to send acknowledge or reject signals to the proxy client for debugging purposes in step 4. But in the simple form presented, it does not provide any information for a would-be “spoofer” to use in trying to hack a proxy client connection.

With the proxy client registered on the intermediary, it only remains for client requests to be sent to a virtual address on the intermediary so that they can be forwarded to the proxy client. The virtual address a client application uses has to satisfy three rules:

1. It should be understood by the client application

2. It should be constructed so that the client request is sent to the intermediary

3. It should include information that the intermediary can interpret to identify the correct proxy client

For the illustration of the embodiment with the HTTP protocol in accordance with FIG. 5, any of the following virtual addresses could be used in a client web browser without the need for configuration changes:

http://www.gkn.net/TUNNEL:www.orang.com or

http://www.gkn.net:2020

or, where the intermediary zone has been subdivided

http://orang.gkn.net

or, where the public DNS entry for www.orang.com has been delegated to the intermediary

http://www.orang.com

or, where a secure client web connection is required

https://www.orang.com

All of these addresses are consistent with the three requirements laid down for virtual application layer addresses. The first virtual address can be read: use the Hyper Text Transfer Protocol (http://) [rule 1] to access the intermediary Internet server www.gkn.net [rule 2] to get a web page from the proxy client (TUNNEL:) registered for www.orang.com [rule 3].

In the second example, the intermediary has been set-up to pass all communications sent to the port 2020 to the www.orang.com proxy client in accourance with rule 3. In the later examples, the intermediary interprets the HOST: directive of the HTTP protocal to find the correct proxy client (HOST: orang.gkn.net or HOST: www.orang.com is interpreted as the www.orang.com proxy client) [rule 3] and DNS entries are used to direct Internet trafic for orang.gkn.net or www.orang.com to the location of the intermediary server [rule 2]. In the last example, the request is sent from the client to the intermediary using Secure Hyper Text Transfer Protocal so that the client to intermediary connection is encrypted. This type of connection could be used in conjunction with a secure proxy client to intermediary connection so as to provide a secure end-to-end communication.

As is consistent with the invention, it can be seen that each of the virtual addressing mechanisms presented extends the Internet address scheme by allowing services to be provided by sharing the static address of a single intermediary machine with a number of service machines.

In continuing with the example, we will assume the user in FIG. 4 issues a web request in accordance with virtual addressing method 1 above. This is interpreted by his web browser as a standard HTTP GET request to be sent to the domain www.gkn.net. A TCP/IP connection would thus be opened from Joe Bloggs to the computer 65.225.115.65 on the Internet and the following HTTP request sent to the intermediary.

GET/tunnel:www.orang.com HTTP/1.1

Accept: */*

Referer: HTTP://www.gkn.net

User-Agent: Mozilla/4.0 (compatible; MSIE 5.01; Windows NT 5.0)

Host: www.gkn.net

The intermediary interprets this request and sees that the ultimate destination is through the www.orang.com proxy client tunnel (line 1 of the request). However, the client request as formatted has been constructed with a virtual address and would not be understood by the ultimate destination service and must be transformed before it is sent to private web server. This transformation can be performed at either the proxy client or the intermediary. In this illustration, we will perform all transformations at the intermediary so that the proxy client merely forwards on requests and responses without transformation.

The transformed HTTP client request is sent to the www.orang.com proxy client connection that was made earlier from the proxy client on the private network. The request as translated is shown below; notice the altered GET and HOST lines in accordance with the removal or the method 1 virtual address:

GET/HTTP/1.1

Accept: */*

Referer: HTTP://www.gkn.net

User-Agent: Mozilla/4.0 (compatible; MSIE 5.01; Windows NT 5.0)

Host: www.orang.com

The translated request is sent as a response to the proxy client connection through the firewall. As far as the firewall is concerned this is a normal response to a request sent from an ephemeral port on the proxy client some time ago and it is mapped back to the proxy client IP and port using the firewalls IP masquerading features.

The proxy client has been waiting for this response on its still open SSL connection to the intermediary server. Upon receiving data, it opens a standard TCP/IP socket connection to the private web server at 1.251.174.157 port 80 and sends the request straight through without the need for any translation. The web server analyses the request and returns a web page. The web page is sent in response to the proxy client TCP/IP socket connection directly to the proxy client (not to the Joe Bloggs client on the Internet).

The proxy client receives the web server response and sends it to the intermediary server through its still-open client SSL connection. This again passes unhindered through the firewall because the connection was initially initiated from within the private network as a client connection some time ago. When the intermediate server receives the response from the proxy client, it forwards it on to the real client 67.227.117.77. In the preferred embodiment this final return of information is through the still-open client to intermediary connection. It is recognised that this response may require translation before it is passed to the client so to that addresses in a web page are transformed into virtual addresses consistent with the virtual address mechanism used.

When the dial-up browser has finished its connection to the orang web server through the intermediary, the client socket connection will be broken. At this point, in the preferred embodiment, the corresponding proxy client connection will also be broken for simplicity. And, in any case, when the proxy client to intermediary connection is broken, the proxy client will automatically initiate a new fresh client connection to the intermediary computer and terminate any service socket connections.

If the web server requires authentication, a normal challenge response will be sent back from the web server to the proxy client and to the dial-up web browser allowing for client authentication at the service application level. Alternatively, client authentication can be performed using any method (PAP, host address, CHAP, Public Keys, X.509 etc.) at the intermediary or proxy client.

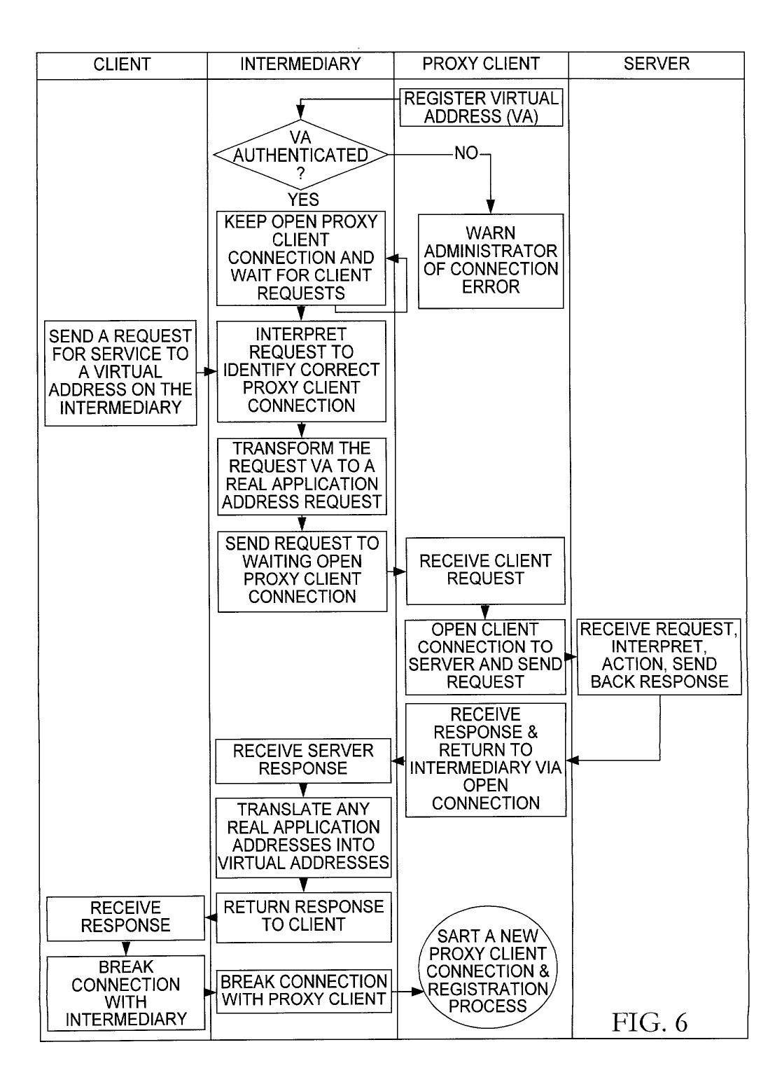

A flow chart for the point-to-point communication process of this first illustration is provided in FIG. 6.

Those skilled in the art will see how this virtual addressing scheme can be extended to other application protocols. Take for example the SMTP protocol used for e-mail delivery over the Internet. Here, a public DNS MX record can be set-up for the orang.com zone that delegates e-mail to the gkn.net zone. A proxy client on the orang.com private network would register itself with the gkn.net intermediary and forward client requests on the private network to the mail server 1.251.174.155 port 25. The intermediary would analyse all incoming SMTP protocol RCPT TO: directives to identify the zone of the e-mail. SMTP client requests for anyone@orang.com would thus be forwarded to the orang.com mail proxy client. Note that no translation would be required with the SMTP protocol and the proxy client could register itself with a different name (say mail.orang.com:25 where :25 indicates client connections to port 25) on the intermediary so that two or more services can be provided through different proxy clients on the same network using the same intermediary in accordance with the invention.

Although SSL was used to secure the proxy client registration and an SSL virtual addressing method was presented, the method is flexible enough to be secured in other ways including IPSec and Block and Stream encryption (RSA, RC4, Public and Private key) if required.

The slowest part of the process is the client connection to the Internet (a 56 k dial-up modem here). Request analysis and any translation takes a fraction of the modem transfer time as does any delays associated with the chained connections on a fast inter-network like the Internet. Additionally, the intermediary to proxy client communications can be compressed (using standard stream or block techniques) to give enhanced performance over naked communications. Thus this embodiment can be used to actually speed-up a traditional communications channel.

### EMBODIMENT 2: NETWORK LAYER VIRTUAL ADDRESSING SCHEME

In a second preferred embodiment of the present invention, the proxy client component is configured to repeat network layer datagrams on the private network This is distinct from embodiment 1 in that lower level protocols (ICMP, IP, NetBIOS etc.) can be bridged between networks through the intermediary allowing for the construction of a Virtual Private Network (VPN). To illustrate this embodiment, without the intention of limitation, a VPN connection will be examined between the main orang.com home office private network (1.251.174.0) and one of their satellite offices (192.168.22.0) which will be used for sending a e-mail with the SMTP application protocol over a TCP/IP transport layer. This example shows the embodiment working independently of the transport or application layer protocols.

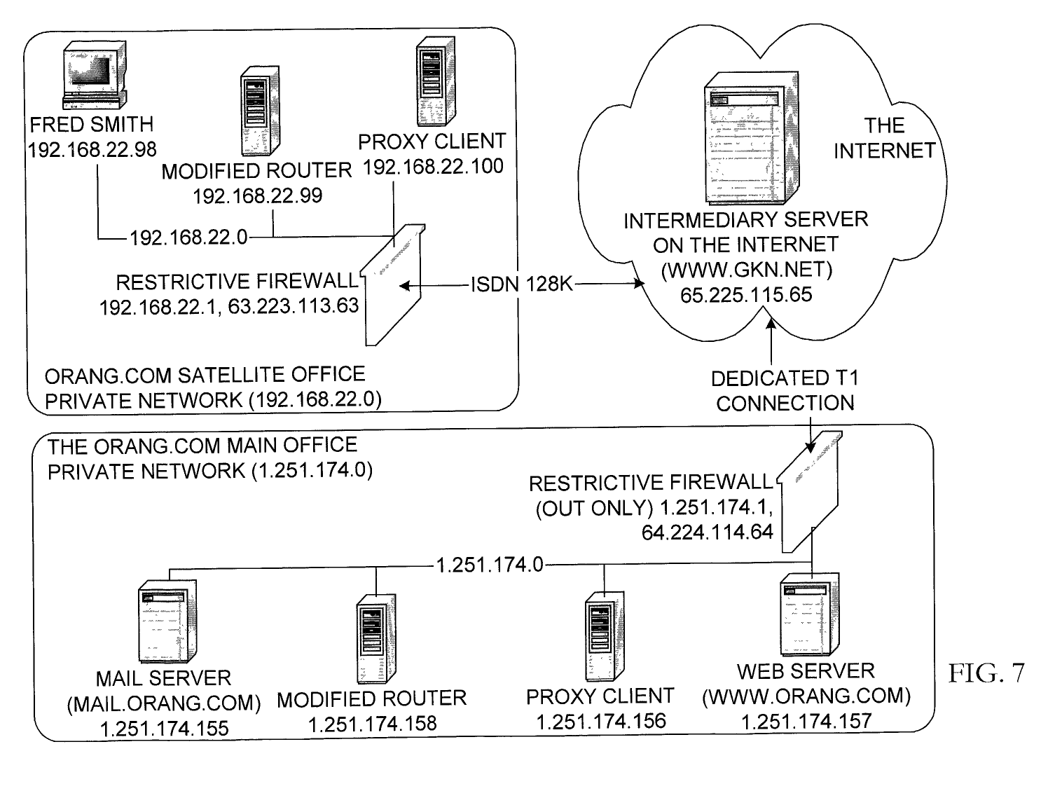

The network topology used to illustrate this embodiment is provided in FIG. 7. The two private networks are both protected by restrictive firewalls with IP masquerading that allow only outbound communication initiated from within the private network to pass (communication with a client characteristic). This topology is commonly used in business today, however it should be understood the invention is not topology or communication technology dependent and will equally well work with a single satellite machine connected to the main office network and two satellite machines connecting together through this embodiment to form a 2 workstation VPN.

In this illustration, a proxy client component has been included in both private networks. This component is on a separate machine although this is not a requirement. Also included in both networks is a modified router (machines 192.168.22.99 and 1.251.174.158). Network datagrams destine for a computer on the opposite network are, in this illustration, sent to the modified routers via a static route in the link-layer, encapsulated with virtual address information, sent to the intermediary and passed to the appropriate destination proxy client for repeating at the network layer on the destination network. The mirroring of modified router and proxy clients allows for requests to be sent to the opposite network and responses returned in a similar fashion.

Both the proxy clients on the networks start-up and register their virtual addresses with the intermediary server. This registration is to stop “spoofing” by hackers and is similar to the process presented in the application layer embodiment:

1. Each of the proxy clients opens an outbound Secure Socket Layer (SSL) communication channel with the intermediary using the SSL protocol

2. The two proxy clients send a ‘request’ for registration to the intermediary, through their SSL channels thus:

| | |
|---|---|
| PW: 12345, UN: HomeOffice | PW: 23456, UN: Satil |
| VA: homeoffice.orang.com | VA: satellite.orang.com |

3. The intermediary verifies that the password and username corresponds to the virtual address each proxy client is attempting to register (homeoffice.orang.com and satellite.orang.com) and that the registrations come from a valid host address (in this case the masquerading firewalls 64.224.114.64 and 63.223.113.63 respectively)

4. Given that each registration is consistent with the virtual address the proxy client is attempting to register, the intermediary holds open the proxy client connection ready to pass client requests through. Otherwise it simply closes the respective proxy client connection to refuse the connection

With both proxy clients connected to the intermediary, communication can pass through the restrictive firewalls unhindered as responses to the outbound connections the proxy clients initiated. To complete the communication picture for this embodiment we now examine the stages in sending e-mail from a client on the satellite network to the e-mail server on the main network. From the main network, the e-mail can be picked-up by its intended recipient.

First, Fred Smith on the satellite network (machine 192.168.22.98) starts an e-mail application, creates an e-mail and presses send. The e-mail application on this machine has been set-up to send outgoing e-mail using the SMTP protocol to the 1.251.174.155 machine port 25, which is on the main orang.com network. Before the mail can be sent, the mail application must open a TCP/IP connection to the mail server and send a TCP/IP SYN synchronisation datagram.

The TCP/IP datagram is strictly a transport layer datagram and as this embodiment has been termed a network layer virtual addressing embodiment some explanation may be required. Referring again to FIG. 4 we see that a transport layer datagram is in fact a special type of network layer datagram, in this case we have a network layer IP datagram with Transmission Control Protocol (TCP) data within. Thus the TCP transport layer part of the datagram is encapsulated within an IP network layer datagram and by transporting the network layer we transport the encapsulated transport and application layer data as well.

Continuing with the first TCP/IP SYN synchronisation, the datagram is destined for the address 1.251.174.155, which is not on the subnet of the 192.168.22.0 network. The datagram will thus be routed by the IP router in accordance with IP routing principals (see Stevens, TCP/IP Illustrated Volume 1, February 2000 pp 112). For the illustration in accordance with this network topology, it will be assumed that each network in FIG. 7 is configured with the modified router as their default route for communication to the opposite network. Thus, in the 192.168.22.0 network, the registered route for any communication destined for the 1.251.174.0 network is through 192.168.22.99; and in the 1.251.174.0 network, the registered route for any communication destined for the 192.168.22.0 network is through the 1.251.174.158 modified router.

Thus, the Fred Smith machine recognises that the TCP/IP SYN message destined for 1.251.174.155 must be routed through the local 192.168.22.99 modified router and sends the SYN datagram via the link-layer to the 192.168.22.99 machine. The modified router on the satellite network has been configured to receive datagrams destined for the main orang.com network and send them with a virtual address header to the intermediary at Internet address 65.225.115.65 as an outward bound datagram through the firewall.

The virtual address header added to the TCP/IP SYN message by the modified router is used by the intermediary to identify the correct proxy client to forward the datagram through. The exact header format is implementation dependent, but an example is given here for illustration purposes. In the example the modified router, through the firewall to the intermediary, opens a Secure Socket Layer (SSL) communication channel. The modified router then authenticates that it has access to the destination virtual address with a simple password, username, and destination combination. Then it sends the datagram through the open SSL connection as a stream. This is illustrated below:

PW: 12345, UN: HomeOffice

DEST: homeoffice.orang.com

<<Standard Client Datagram >>

The proxy client or a service application on the destination network could equally well perform client authentication. Other authentication methods aside from username and password include Challenge and Response mechanisms, X.509 Certification, IPSec and host address.

On receiving communications from the modified router, the intermediary identifies the destination proxy client and verifies that the modified router is allowed to communicate with this proxy client (through the username and password here). Given that it is, the intermediary waits to receive the network datagram encapsulated in the SSL communication channel stream and forward it to the waiting proxy client on the destination network. In this example, the SMTP TCP/IP SYN datagram is sent to the intermediary after the authentication and virtual address header in the SSL channel and is forwarded to the orang.com main network through the proxy client connection initiated from machine 1.251.174.156.

On receiving the datagram as a response to its earlier SSL connection with the intermediary, the proxy client simply passes the datagram on through the link-layer. Since the datagram is destined for the 1.251.174.155 machine which is on the same subnet as the proxy client in the illustration network, no routing is required and the link-layer simply obtains the hardware address of the mail server network connection and passes the TCP/IP SYN message on the link-layer.

The mail server TCP/IP protocol stack sends an ACK acknowledgement message back to the Joe Bloggs machine on the satellite network when it receives the TCP/IP SYN message. This return message is routed via the link-layer to the 1.251.174.158 modified router in this example of the preferred embodiment as the destination address for the ACK is 192.168.22.99 which is on the 192.168.22.0 subnetwork. The modified router receives the ACK datagram through the link-layer, adds a destination header to the satellite.orang.com registered proxy client and sends the datagram after the header through a SSL connection to the intermediary for forwarding to the satellite network proxy client.

The satellite proxy client at 192.168.22.100 repeats the TCP/IP ACK message at the link-layer on the satellite network to the hardware address of the Joe Bloggs machine. The Joe Bloggs machine then seamlessly receives the acknowledgement of its datagram as if it were directly routed to the main office network when in fact, its communications have travelled over a secure connection over the Internet and between two restrictive firewalls. The TCP/IP communications continue and the SMTP HELO, MAIL FROM, RCPT TO etc. commands sent in the application protocol layer of TCP packets in IP network layer datagrams to complete the e-mail sending in accordance with this embodiment.

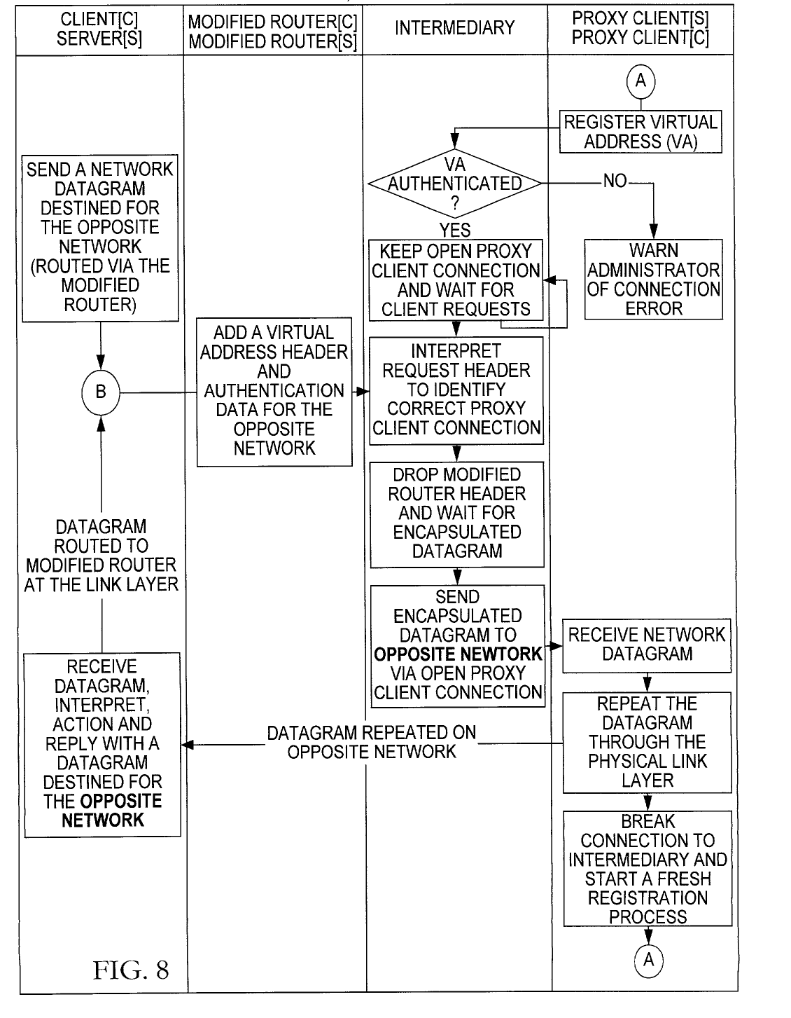

The communication process of this preferred embodiment of the method according to the present invention is disclosed, for the purpose of example only, in FIG. 8.

In this illustration of the second embodiment, network requests are forwarded between the client and server in the sequence:

Client→Modified Router [c]→Intermediary→Proxy Client [s]→Server

Server→Modified Router [s]→Intermediary→Proxy Client [c]→Client

This requires a modified router on both networks. An unmodified router could be used if the client is accessible through a routable address but this would bypass the intermediary and any security constructed over the connection. Alternative approaches include sending the response back to the client through the original client modified router connection with the intermediary (Modified Router [c]) or direct to the client connection where no modified router is used (e.g. with a reconfigured client web browser). This can be achieved with the aid of two modifications while still retaining the security benefits of the intermediary.

Firstly, the modified router could be kept in the destination network and the intermediary modified to return responses through the client modified router connection (or the initial client connection where no modified router is used) that would be maintained open. Secondly, as an aid to the intermediary in patching responses to the correct client connection, the service proxy client (proxy Client [s]) could be configured to alter the datagram before it repeats them on the service network. This alteration could be to modify the IP from address so as to masquerade on the destination network as the client and receive responses from the server instead of them being routed through the service modified router. The proxy client would then return these datagram responses to the intermediary, after correcting the returned IP “to” address, through its open intermediary connection and the intermediary would patch these responses to the correct ultimate client connection without the need of a modified router on the return path. The sequence of the response messages would then become:

Server→Modified Router [s]→Intermediary→Modified Router [c]→Client

or

Server→Proxy Client [s]→Intermediary→Modified Router [c]→Client

Obvious other sequence modifications exist including returning responses through the client network proxy client (S:PO[s]:I:PO[c]:C).

Although SSL was used to secure the modified router to intermediary and proxy client to intermediary connections, the invention is compatible with other encryption techniques including block and stream ciphers (such as RSA, Blowfish, RC2, RC4 etc.) as required. This embodiment can also be used with compression to achieve improved inter-network communication speeds.

In another embodiment of the invention, a client is configured to use the intermediary as a proxy server. Thus all communications pass to the intermediary from the client without the need for additional components or virtual addressing. The intermediary analyses the requests at the various protocol layers and determines which proxy client to send the request through as illustrated.

In yet another embodiment a client component working at the application layer is added to a client network. This client component is similar in concept to a proxy server on the client network, and clients are configured to use it as a proxy server. The client component is different from a proxy server however in that it encapsulates requests with a header to the requests that identify the virtual server the intermediary machine is to pass the communication through.

Along with the objects, advantages and features described, those skilled in the art will appreciate other objects, advantages and features of the present invention still within the scope of the claims as defined. For instance, the client and service provider can be on disparate physical networks that are prohibited from passing incoming connections between them by the use of firewalls and proxy servers (e.g. a private company intranet), on the same network and consolidated into a single address scheme through the invention or the service providing machine could be connected to the Internet through an ISP which assigns dynamic addresses or dial-up. In these and other cases where a client application can not reliably either know the address of or otherwise contact a service providing application, the present invention makes their inter-communication possible through the use of an intermediary machine that they can both connect to using outgoing client connections and the use of a proxy client component that removes the need for changing existing service and client applications.

Because of the nature and reliability of inter-network communications and as an optimisation method, a proxy client can open several connections for a virtual address to the intermediary simultaneously. The connections can be used independently of one another or in series by the intermediary and the proxy client can maintain the number of outgoing connections when connections are dropped. This allows for multi-threaded access between networks and allows for connections to be dropped without severely degrading performance.

In summary, a method or system has been described for the provision of services over a communication channel such as the Internet or a private network, wherein the services are provided through an intermediary apparatus. The intermediary apparatus and components described allow for services to be provided in situations where a client would not normally be able to communicate with a service because, for example, the service is protected behind a restrictive firewall (that is: a firewall that allows only outward bound connections), proxy server or is on a machine with a dynamically assigned address and allows a service-providing machine to be addressed through a virtual address on the intermediary.

A new communication component has been introduced called a proxy client. This component allows communication with a service on a private service-providing network without the need for any software changes or reconfiguration. The proxy client component achieves its aim by opening an outward-bound connection from the service-providing network through any restrictive firewall or proxy server as a client to the intermediary apparatus. The component then, in the preferred embodiments, waits for service requests to be returned through the open connection with the intermediary machine and forwards these requests on the private network to the service provider.

The invention and embodiments are not limited to a particular network topology, service or communication protocol and can be implemented in a number of ways in different layers of the network or communication protocol stack. Two detailed embodiments have been described from which others can be derived. The first uses virtual addressing at the application layer to route requests from client software through the intermediary apparatus. This embodiment is characterised by the proxy client masquerading as the true client on the service network and no additional or modified client component requirements. This embodiment is particularly suited for providing known Internet application services such as web and e-mail from behind an Internet gateway (using virtual address schemes in the HTTP and SMTP application protocols respectively).

The second embodiment uses a virtual addressing scheme at the network or transport layer as opposed to the application layer. The embodiment can be characterised by the forwarding of network datagrams through the intermediary machine. The datagrams can either be encapsulated with an optional virtual address header which identifies the destination proxy client and is routable to the intermediary machine, or they can be directed to the intermediary apparatus configured to act as a proxy server for a service machine or network (e.g. by setting-up public DNS records delegating the intermediary as the real server for Internet clients or by reconfiguring clients) through the proxy client.

The services provided are not limited by the invention and the invention is particularly suited for connecting private networks through the Internet with encryption to provide a Secure Virtual Private Network. The invention is also particularly suited for providing point-to-point access to a company web server, mail server or application server located within a private network through the Internet. Other benefits include the unlimited extension of an addressable communication scheme by the provision of virtual static addresses through the intermediary apparatus.

We claim:

1. A method of connecting, communicating or establishing communication between a client application on one client to a service application on another client, the method comprising a service application or component associated therewith on the other client establishing a first client-type connection with an intermediary, intermediary server or intermediary apparatus and the client application on the one client or component associated therewith establishing a second client-type connection with the intermediary, intermediary server or intermediary apparatus.

2. A method of connecting, communicating or establishing communication between a client application on a client and a server or service network, the method comprising the server or service network or a component associated therewith establishing a first client-type connection with an intermediary, intermediary server or intermediary apparatus and the client application on the client or a component associated therewith establishing a second client-type connection with the intermediary, intermediary server or intermediary apparatus.

3. A method of connecting, communicating or establishing communication between a client application on a server or service network and a service application on a client, the method comprising the service application or a component associated therewith establishing a first client-type connection with an intermediary, intermediary server or intermediary apparatus and a client on the server or service network or a component associated therewith establishing a second client-type connection with the intermediary, intermediary server or intermediary apparatus.

4. A method of connecting, communicating or establishing communication between a client of one server or service network and another server or service network, the method comprising the other server or service network or a component associated therewith establishing a first client-type connection with an intermediary, intermediary server or intermediary apparatus and the client of the one server or service network or a component associated therewith establishing a second client-type connection with the intermediary, intermediary server or intermediary apparatus.

5. A method of connecting two machines for communication therebetween, the method comprising one machine or a component associated therewith establishing a client-type relationship with an intermediary, intermediary server or intermediary apparatus and another machine or a component associated therewith establishing a client-type relationship with the intermediary, intermediary server or intermediary apparatus.

6. A method of establishing a Virtual Private Network between machines or service networks, the method comprising a first machine or service application or component associated therewith establishing a first client-type connection with an intermediary, intermediary server or intermediary apparatus and a second machine or service application or component associated therewith establishing a second client-type connection with an intermediary, intermediary server or intermediary apparatus.

7. A method according to any one of claims 1 to 6, the method further comprising receiving a communication, data or request from the client on the second connection and routing said communication or request along the first connection to the service application, server or service network or component associated therewith.

8. A method according to claim 7, the method further comprising receiving a communication or response from the service application, server or service network or component associated therewith on the first connection and routing said communication or response along the second connection to the client or client application.

9. A method according to any one of claims 1 to 8, wherein said component associated with the service application, server or service network is a proxy client or proxy client component with a client relationship with the service application, server or service network.

10. A method according to claim 9, wherein said proxy client or proxy client component receives the communication, data or request and passes said request to the associated service application, server or service network and forwards any response along the first connection to the intermediary.

11. A method according to claim 10, wherein the proxy client or proxy client component:
a) Acts as a client to the intermediary server and the service application, server or service network;
b) Initiates the first connection or subsequent connection with the intermediary server for receiving client requests;
c) Operably waits for the client request to be forwarded through the first connection;
d) Forwards the client request to the service application, server or service network; and
e) Forwards any responses from the service application, server or service network back to the intermediary server.

12. A method according to any one of claims 1 to 11, the method further comprising establishing the first connection, preferably holding open said first connection, establishing the second connection, receiving a request from the client on the second connection and routing said request along the first connection to the service application, server or service network.

13. A method according to claim 6 or any one of claims 7 to 12 when appended to claim 6, the method further comprising establishing the first connection, preferably holding open the first connection, establishing the second connection, receiving a client request from one machine or network through one of the connections and forwarding the client request along the other connection.

14. A method according to claim 13, the method further comprising receiving a response from said other connection and routing said response along said one of the connections.

15. A method according to any one of claims 6, 13 or 14, wherein a first proxy client or proxy client component with a client relationship with the first server, network or service application establishes the first connection and a second proxy client or proxy client component with a client relationship with the second server, network or server application establishes the second connection.

16. A method according to claim 15, wherein the first proxy client via the intermediary site receives requests from one or more clients of the second machine or network and processes said requests on a machine or network accessible to the first proxy client and returns the responses via the intermediary server, and the second proxy client via the intermediary site receives requests from one or more clients of the first machine or network and processes said requests on a machine or network accessible to the second proxy client and returns the responses via the intermediary server.

17. A method according to any one of claims 1 to 16, wherein a network request is forwarded by a client on one machine or network via a preferably modified router, a modified proxy server or special client configuration on or accessible to said machine or network to the intermediary site and then to the proxy client of the other server.

18. A method according to any one of claims 1 to 17, wherein a network response from said other machine or network is returned via a preferably modified router, a proxy client on said other machine or network to the intermediary site, to the proxy client of said one machine or network and then to said client on the one machine or network.

19. A method according to any of the preceding claims, the method allowing the publication of restricted services (behind a firewall, gateway, proxy server, using dynamic addresses or otherwise inaccessible) to clients on another network through the use of an intermediary.

20. A method according to any one of the preceding claims incorporating a virtual addressing facility whereby requests are forwarded from the intermediary through, preferably open, client-type connections as initiated by proxy client like components.

21. A method according to claim 20 incorporating application layer addressing, network or transport layer addressing.

22. A method according to claim 17, wherein a network response from said other machine or network is returned via other means on said other machine or network to the said original client on the one machine or network.

23. A method according to claim 17, wherein a network response from said other machine or network is returned via the intermediary site, to the modified router or original client of said one machine or network.

24. A method according to claim 20, wherein the addressing allows services to be presented through a virtual address on an intermediary machine.

25. A method according to claim 24, wherein the addressing allows services to be presented through a virtual address on an intermediary machine in an immediate manner so as to remove the need for file transfers and reconfigurations.

26. A method according to claim 25, wherein the addressing allows multiple services to be collated into a single address space.

27. A method according to any of the preceding claims, wherein the intermediary and virtual addressing allows services to be load distributed or clustered between multiple servers.

28. A method according to any of the previous claims, wherein the intermediary, proxy client or modified router are used to broadcast or multi-cast client requests to one or more service or service network and/ or service responses to one or more service or service network.

29. A method of Internet or Internet-type communication, the method comprising a first client or server establishing a client-type relationship with an intermediary server, a second client or server establishing a client-type relationship with the intermediary server and the intermediary server facilitating communications between the first client or server and the second client or server through the use of an intermediary and proxy client component.

30. A method according to any of the preceding claims, the method using one or more of encryption, data compression or authentication.

31. A method according to any one of the preceding claims, wherein any of data, signals, messages, requests and responses are transferred between two applications.

32. A method according to any one of the preceding claims, the method shielding the identity of a client-service action.

33. A method according to any one of the preceding claims, the method providing a secure communication channel.

34. A method substantially as described herein with reference to the accompanying drawings.

35. Means for carrying out a method of any one or more of claims 1 to 34, including software means.

36. A system adapted for carrying out a method of any one or more of claims 1 to 34, including a system incorporating a server.

37. A system substantially as described herein with reference to the accompanying drawings.

38. A proxy client or proxy client component comprising:
a) Means to act as a client to a service application, server or service network;
b) Means to act as a client to an intermediary server;
c) Means to initiate a first or subsequent connection with the intermediary server;
d) Means to wait and receive a client request through the first connection;
e) Means to forward the client request to the service application, server or service network; and
Optionally, means to forward any response from the service application, server or service network back to the intermediary server.

39. A proxy client or proxy client component substantially as described herein with reference to the accompanying drawings.

40. A server configured to act as an intermediary server, the server comprising:
a) Means to allow a first client-type connection to be established with the server;
b) Means to allow a second client-type connection to be established with the server; and
c) Means to route a request from the first client-type connection to the second client-type connection for the purpose of processing the first request.

41. An intermediary server substantially as described herein with reference to the accompanying drawings.

42. A Virtual Private Network comprising machines or networks connected via client-type connection with an intermediary server.

43. A Virtual Private Network substantially as described herein with reference to the accompanying drawings.

44. A modified router or modified router component comprising:
a) Means to allow the capture of client network request and service network response datagrams;
b) Means to encapsulate datagrams with optional virtual addressing information interpretable by an intermediary, intermediary server or intermediary apparatus; and
c) Means to forward an encapsulated request to the intermediary for further forwarding through a proxy client type connection with the intermediary.

45. A modified router substantially as described herein with reference to the accompanying drawings.
